(19) United States
(12) Patent Application Publication
(10) Pub. No.: US 2012/0096857 A1
(43) Pub. Date: Apr. 26, 2012

(54) Heat utilization device an operating method

(76) Inventors: Jan Gärtner, Leonberg, DE (US); Thomas Koch, Boblingen (DE)

(21) Appl. No.: 13/317,836

(22) Filed: Oct. 28, 2011

Related U.S. Application Data
(63) Continuation-in-part of application No. PCT/EP2010/001720, filed on Mar. 18, 2010.

(30) Foreign Application Priority Data
Apr. 29, 2009 (DE) 10 2009 019 385.5
Sep. 15, 2009 (DE) 10 2009 041 550.5

(51) Int. Cl. F02G 5/00; F01K 13/00

(52) U.S. Cl. 60/618; 60/645

(57) ABSTRACT

In a method for operating a waste heat utilization device comprising a working fluid which is liquefied after expansion in an expander by a condenser of the heat utilization device, by controlling an inflow cross-section to an expander of the waste heat utilization device a low pressure of the working fluid in the region of the condenser for adjusting the condensation temperature of the working fluid in the condenser, to provide for a heat transfer flow from the working fluid to the condenser environment sufficient to ensure the complete liquefication of the working fluid in the condenser.

This is a Continuation-In-Part application of pending international patent application PCT/EP2010/001720 filed Mar. 18, 2010 and claiming the priority of German patent applications 10 2009 019 385.5 filed Apr. 29, 2009 and 10 2009 041 550.5 filed Sep. 15, 2009.

### BACKGROUND OF THE INVENTION

The present invention relates to a method for operating a heat utilization device, in particular of a motor vehicle, having a working fluid which is condensed after expansion in the heat utilization device. The heat utilization device is particularly suitable as a waste heat utilization device of an internal combustion engine, especially of a vehicle.

U.S. Pat. No. 5,327,987 discloses a hybrid vehicle with an internal combustion engine driving a first vehicle axle, with an electric motor driving a second vehicle axle and with a waste heat utilization device using waste gas heat and internal combustion engine heat, wherein a pressure regulating unit is provided to regulate a high pressure in the region of a heat supplying heat exchanger of the waste heat utilization device.

DE 10 2004 024 402 A1 describes a heat engine with an expander and with an electric machine which can be used as a power generator or electric motor. A power transmission device arranged between the expander and the electric machine is in the form of a planet gear, the expander, the electric machine and the power transmission device being arranged in a common housing.

A heat utilization device in the form of a Clausius Rankine cycle, which is described in DE 10 2007 024 894 A1, is connected via a condenser of the heat utilization device to a cooling cycle, whereby both cycles jointly use both, the working fluid and also the condenser. Herein, a working fluid mass flow of the Clausius Rankine cycle is reduced if a predetermined overall working fluid mass flow of both cycles exceeds a pre-set threshold value.

U.S. Pat. No. 7,174,732 B2 describes a heat utilization device with an expander, a condenser, a feed pump and an evaporator, wherein the speed of a fan of the condenser is controlled on the basis of a signal of a pressure sensor arranged after the expander and before the condenser. The pressure prevailing downstream of the expander is regulated by controlling the fan.

A problem with the use of a heat utilization device in an overall system such as for example in a motor vehicle equipped with an internal combustion engine is, among other things, a design of the heat utilization device which is limited essentially by the ability of the overall system to remove waste heat in a condenser of the heat utilization device. This problem in turn has to be taken into consideration in the design of the overall system, as the heat utilization unit can be damaged by overheating when a quantity of waste heat can no longer be removed by the condenser.

The present invention deals with the problem of providing a method for operating a heat utilization device and a heat utilization device in particular for use as a waste heat utilization device of an internal combustion engine. An improved embodiment is desirable which, in particular during a high load operation of an evaporation heat source of the heat utilization device, cannot be damaged by overheating without a over-dimensioning the heat utilization device in a costly manner.

### SUMMARY OF THE INVENTION

In a method for operating a waste heat utilization device comprising a working fluid which is liquefied after expansion in an expander by a condenser of the heat utilization device, by controlling an inflow cross-section to an expander of the waste heat utilization device a low pressure of the working fluid in the region of the condenser for adjusting the condensation temperature of the working fluid in the condenser, to provide for a heat transfer flow from the working fluid to the condenser environment sufficient to ensure the complete liquefication of the working fluid in the condenser.

The invention is based on the general idea of increasing the condensation temperature in a condenser of the heat utilization device by raising a low pressure prevailing in the region of the condenser so that a gaseous working fluid coming from an expander of the heat utilization device can be completely liquefied in the condenser. If the working fluid is not completely liquefied in the condenser a feed pump of the heat utilization device following in a working fluid path must provide for liquefying the partially gaseous or vapor-form working fluid. In this case either the feed pump must be designed for such a process with high costs resources or it is damaged over time by the periodic occurrence of gaseous or vapor-form working fluid. This can be avoided by increasing a condensation temperature in the condenser. A cost-effective design of the heat utilization device is thereby obtained.

This is preferably achieved through a reduction in the expansion ratio. The expansion ratio is defined as the ratio of the pressure before the expansion to the pressure after the expansion. The pressure ratio or expansion ratio is in direct connection with the volume ratio, thus the ratio of the volume before the expansion to the volume after the expansion, of the expander. This volume ratio can be reduced by adapting the valve control times in reciprocating engines or in slot-controlled engines by adapting the slot control times or a variable turbine geometry. Alternatively or additionally a throttle can also be used.

A reduction in the expansion ratio can be achieved by raising the low pressure in the cycle, lowering the high pressure or a combination of both.

In one embodiment the reduction in the expansion ratio takes place through an increase in an inflow cross-section of an inflow path of the working fluid to the expander. The low pressure can thereby be increased by opening the inflow cross-section of the working fluid to the expander. Subsequently, by opening the inflow cross-section the low pressure is increased in a low pressure path of the working fluid virtually simultaneously with the increase in the condensation temperature in the low pressure path.

In a further embodiment the reduction in the expansion ratio takes place in that the low pressure is adjusted by changing the speed of the expander.

In another embodiment the reduction in the expansion ratio takes place in that the low pressure is adjusted through a slot control in the inflow cross-section of the working fluid to the expander.

In addition to the measure of increasing the low pressure a heat transfer flow from the working fluid to a condenser environment can also be enlarged by increasing a working fluid mass flow. This is, however, only sufficiently effective in cooperation with the increase in the condensation temperature, as in case of a very low temperature difference between the condensation temperature and an ambient temperature of the condenser environment the heat transfer flow is virtually negligible. Correspondingly a reduction in the working fluid mass flow necessitates a reduction in the heat transfer flow from the working fluid to a condenser environment. The ambient temperature can thereby be established at least partially by the temperature of a cooling medium of the condenser.

The abovementioned features and the features to be described below can be used not only in the respectively indicated combination but instead also in other combinations or alone without going outside of the scope of the present invention.

The invention and preferred embodiments of the invention will become more readily apparent from the following description of a particular embodiment of the invention with reference to the accompanying drawings.

### BRIEF DESCRIPTION OF THE DRAWINGS

FIG. 1 shows a pressure enthalpy diagram of a Clausius Rankine cycle in normal operation, and

FIG. 2 shows a pressure enthalpy diagram of a Clausius Rankine cycle in high load operation with an increased low pressure and associated also increased condensation temperature in the low pressure path.

### DESCRIPTION OF A PARTICULAR EMBODIMENT

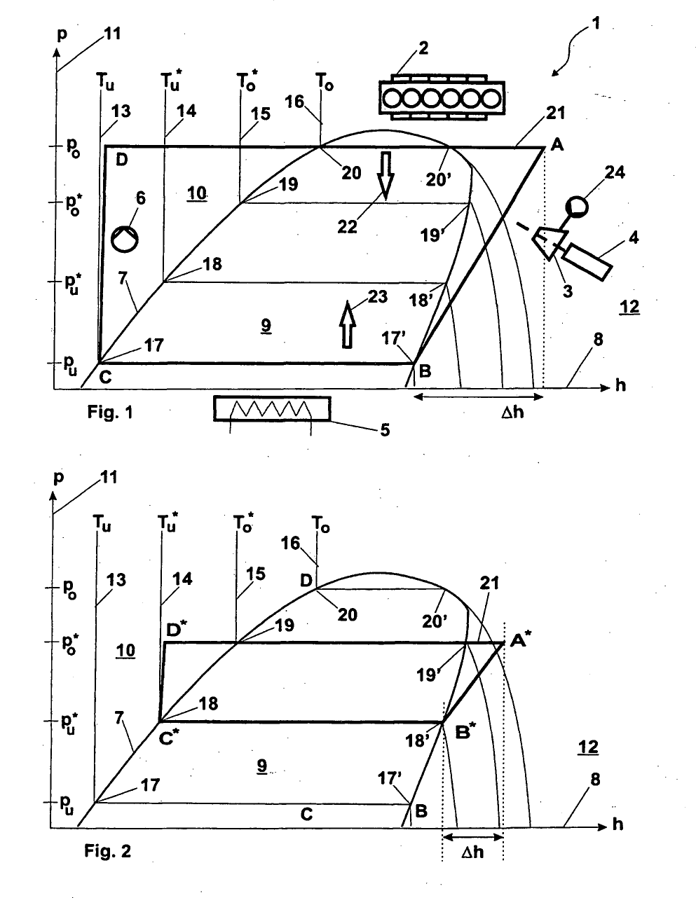

FIG. 1 shows a heat utilization device 1 which comprises an evaporation heat source 2, such as for example an internal combustion engine, as a high temperature heat source, an expander 3 with a power converter 4, a condenser 5 as a low temperature heat source and a feed pump 6. Heat is thus transferred from the evaporation heat source 2 as a high temperature heat source to the condenser 5 as a low temperature source and a part of the transferred heat is thereby converted through the heat utilization device 1 into useful mechanical work, while at the same time the evaporation heat source 2 is cooled through the transfer and a condenser environment of the condenser 5 is heated. Also shown is a pressure enthalpy curve 7 of a working fluid of the heat utilization device 1 which, together with an x axis 8, on which the enthalpy h is entered, surrounds a region 9 which characterizes a simultaneous presence of a gaseous and a liquid aggregate state of the working fluid. A region 10 between the pressure enthalpy curve 7 and a y axis 11, on which the pressure p is entered, characterizes the presence exclusively of the liquid aggregate state of the working fluid. A region 12, which is arranged after the region 9 in the direction of the x axis 8, characterizes the exclusive presence of the gaseous aggregate state of the working fluid.

A plurality of evaporation curves 13, 14, 15, 16 represent the behavior of the working fluid at different temperatures T_{O}, T_{O}*, T_{U}*, T_{U} with decreasing pressure. Beginning in the region 10 of the liquid aggregate state of the working fluid the evaporation curves 13, 14, 15, 16 exhibit a virtually isenthalpic behavior. With decreasing pressure the evaporation curves 13, 14, 15, 16 thereby run virtually parallel to the y axis 11 until they meet the pressure enthalpy curve 7 at several curve points 17, 18, 19, 20. At these curve points 17, 18, 19, 20 the working fluid begins at the respective temperature T_{O}, T_{O}*, T_{U}*, T_{U} and at a pressure P_{O}, P_{O}*, P_{U}*, P_{U} defined by the respective curve point 17, 18, 19, 20 to go from the liquid into the gaseous state. As this process takes place isobarically the evaporation curves 13, 14, 15, 16 in the region 9, which characterizes the presence of the liquid and the gaseous aggregate state of the working fluid, are parallel to the x axis 8. The evaporation curves 13, 14, 15, 16 meet in the region 9 for a second time with the pressure enthalpy curve 7 at several points 17′, 18′, 19′, 20′. Following the curve pattern of the evaporation curves 13, 14, 15, 16 starting from the region 10, all working fluid has gone from the liquid aggregate state into the gaseous aggregate state at the curve points 17′, 18′, 19′, 20′. The curve pattern of the evaporation curves 13, 14, 15, 16 in the region 12 of the gaseous aggregate state of the working fluid thus shows the behavior of the working fluid in the gaseous aggregate state with further pressure reduction. According to the pattern of the evaporation curves 13, 14, 15, 16 in the region 12 this process is not isenthalpic.

Furthermore a cycle 21 is shown in FIG. 1 which illustrates the different states A, B, C, D of the working fluid in the cycle 21. At point A, which is arranged in the region 12 of the gaseous aggregate state, the working fluid is present as overheated vapor or overheated gas. On the way from A to B the gas flows through the expander 3 whereby the working fluid experiences a pressure drop and a temperature reduction. An enthalpy difference Δh is thereby converted through the expander 3 into useful work. On the way from B to C the working fluid is liquefied by the condenser 5. Subsequently the working fluid flows on the way from C to D through the feed pump 6 and experiences a virtually isenthalpic pressure increase, as the enthalpy increase is, in case of an isoentropic process a product of volume and pressure difference, in case of compression of liquids in comparison with other enthalpy differences of the cycle 21 very low. On the way from D to A the liquefied working fluid is only heated as far as the evaporation temperature in the evaporation heat source 2, then evaporated and a vapor of the working fluid produced is overheated as far as point A through the waste heat of the evaporation heat source 2. On the way from D to A, thus when the working fluid flows through the evaporation heat source 2, there is an evaporation temperature T_{O} of the working fluid. This evaporation temperature T_{O} represents the evaporation temperature of the working fluid under the prevailing high pressure P_{O}. On the way from B to C, thus when the working fluid flows through the condenser 5, there is a condensation temperature T_{O} of the working fluid under the low pressure P_{U} prevailing in the condenser 5.

The above-described cycle with the states A, B, C, D of the working fluid constitutes essentially an ideal cycle. It is, however, also conceivable that the status point B does not lie precisely on the pressure enthalpy curve 7. If the working fluid is already liquefied in part while flowing through the expander 3 the status point B lies within the region 9. In this case the enthalpy difference Δh and thus the energy yield of useful mechanical work is increased. If the vapor-form working fluid must be further cooled while flowing through the condenser 5 before it can be liquefied the status point B is arranged in the region 12. It is also possible for the status point C not to lie on the pressure enthalpy curve 7 either. If there is cooling down through the condenser 5 to such an extent that the working fluid is sub-cooled beyond being liquefied the status point C lies in the region 10. If the condenser 5 does not manage to completely liquefy the working fluid the status point C lies within the region 9.

A temperature difference ΔT between the ambient temperature of the condenser environment and the condensation temperature T_{U} of the working fluid is decisively responsible for the magnitude of the heat transfer flow dQ between the working fluid and the condenser environment. The heat transfer thereby takes place between the condenser environment and the working fluid according to the following formula:

dQ=α·A·ΔT·dt

wherein A is the area of the heat transfer,
ΔT is the temperature difference between the ambient temperature, of the condenser 5 and the condensation temperature T_{U} of the working fluid, and
α is the heat transfer coefficient which, inter alia, is dependent upon the working fluid mass flow.

As can be seen from the above formula, the level of the heat transfer flow dQ can likewise be increased through a working fluid mass flow, as the heat transfer coefficient α depends upon the working fluid mass flow and is all the greater the greater the working fluid mass flow.

In a preferred embodiment of an operating method for a heat utilization device 1, wherein the condenser 5 must liquefy the working fluid, it can be advantageous in certain situations to raise the condensation temperature T_{U} of the working fluid in the condenser 5. Since, as a result, the temperature difference ΔT is increased an increased heat transfer flow dQ from the working fluid to the condenser environment is achieved according to the above formula. Such an increase in the condensation temperature T_{U} is obtained by raising the low pressure P_{U}. If such a raising of the low pressure P_{U} to P_{U}*is carried out the cycle 21 is displaced in a section B/C in a direction 23. At the same time the evaporation temperature T_{O} and the high pressure P_{O}, which prevails in the working fluid e.g. upon flowing through the expander 2, can be lowered. By this lowering of the high pressure P_{O} and the evaporation temperature T_{O} the cycle 21 is displaced in a section D/A in a direction 22. The lowering of the high pressure is not a compulsory consequence but is typically dependent upon a system fill quantity of working fluid, the design of the expander and its operating strategy as well as a pump feed quantity.

FIG. 2 shows the result of such an increase in the low pressure from P_{U}. to P_{U}* in relation to the cycle 21. According to FIG. 2 the working fluid therefore has, while for example flowing through the evaporation heat source 2, a reduced high pressure P_{O}* and a reduced evaporation temperature T_{O}*. At the same time the low pressure P_{U}* and the condensation temperature T_{U}* of the working fluid are increased for example upon flowing through the condenser 5. Through such a measure the complete liquefication of the working fluid is facilitated in the condenser 5.

The change in the low pressure from P_{U} to P_{U}* is possible through reduction of the expansion ratio, e.g. by changing an inflow cross-section of an inflow path of the working fluid to the expander 3 of the heat utilization device 1. The inflow cross-section is reduced or enlarged in a useful embodiment through a throttle means 24 in the form for example of a throttle valve, a variable turbine geometry or similar as required. An increase in the low pressure P_{U} and the condensation temperature T_{U} of the working fluid in the region of the condenser 5 is realized automatically and simultaneously by the enlargement of the inflow cross-section, with also a simultaneous increase in the high pressure P_{O} and the evaporation temperature T_{O} in the region of the evaporation heat source 2. It is thus possible to react immediately to a load peak, in particular in a transient high load region, by increasing the condensation temperature T_{U} of the working fluid and to protect the heat utilization device from damage by overheating. It is advantageous thereby that through such a regulation method the load range, in particular in high load operation, is less limited by the heat transfer capacity of the condenser 5 in the installation position.

The low pressure P_{U} and thus also the condensation temperature T_{U} can likewise be adapted to the respective situation through a change in speed of the expander 3.

In a further embodiment, in addition to increasing the condensation temperature T_{U} by changing a pump speed, the working fluid mass flow can be increased e.g. by the feed pump 6. An increase in the working fluid mass flow leads via the enlargement of the heat transfer coefficient α to an increased heat transfer flow dQ from the working fluid to the condenser environment.

An unfavorable factor in an increase in the working fluid mass flow is the fact that, in spite of an increase in the heat transfer coefficient and the transferred heat, the heat quantity to be removed for complete condensation of the working fluid increases.

For this reason it is advantageous with such an increased low pressure P_{U}* to also simultaneously reduce the working fluid mass flow, as the heat power to be transferred in total in the condenser, which is at least proportional to the mass flow, is reduced. In contrast the disadvantage of a slight reduction in the removable power is negligible.

A preferred embodiment considers that precisely in a high load operation of the evaporation heat source 2 of the heat utilization device 1 possibly the condenser 5 can no longer completely remove the heat quantity arising and due to this a complete condensation of the working fluid is no longer ensured. Particularly in this case an increase in the heat transfer flow dQ takes place by increasing the condensation temperature T_{U} of the working fluid. As more heat can now be transferred from the working fluid to the condenser environment complete liquefication of the working fluid is obtained again.

The ambient temperature of the condenser environment is thereby also considered in a further developed embodiment and possibly also the condensation temperature T_{U} of the working fluid adapted in a normal load operation. This can be necessary with very high ambient temperatures, e.g. in summer, in order to guarantee complete liquefication of the working fluid.

In this connection an advantageous embodiment can be equipped with a sensor unit which determines the pressure and/or the temperature at least one point of the cycle 21. Due to the at least one determined measurement value the low pressure P_{U} is then adapted. For this reason it can be advantageous to determine the pressure and/or the temperature in the condenser 5 shortly after the expander 3 and also in the evaporation heat source. The determination of the working fluid mass flow is also advantageous.

In a preferred embodiment the cycle 21 is in the form of a Clausius Rankine cycle. However, an arrangement using a Carnot cycle, a Stirling cycle or similar is also conceivable.

A heat utilization device 1 which is used in the above manner as a waste heat utilization device of an internal combustion engine has the advantage that the whole heat utilization device 1 can be dimensioned smaller without being damaged in particular situations by overheating.

### LIST OF REFERENCE NUMERALS

1 Waste heat utilization device
2 Evaporation heat source
3 Expander
4 Power converter
5 Condenser
6 Feed pump
7 Pressure enthalpy curve
8 X axis
9 Region
10 Region
11 Y axis
12 Region
13 Evaporation curve T_{O}
14 Evaporation curve T_{U}*
15 Evaporation curve T_{O}^{*}
16 Evaporation curve T_{O}
17, 17′ Curve point
18, 18′ Curve point
19, 19′ Curve point
20, 20′ Curve point
21 Cycle
22 Direction
23 Direction
24 Throttle means
A Status point of the working fluid
B Status point of the working fluid
C Status point of the working fluid
D Status point of the working fluid
T_{O}, T_{O}* Evaporation temperature
T_{U}, T_{U}* Condensation temperature
Pₒ, Pₒ* High pressure
P_{U}, P_{U}* Low pressure
ΔH Enthalpy difference
H Enthalpy

What is claimed is:

1. A method for operating a heat utilization device (1) in a motor vehicle, the heat utilization device (1) comprising a working fluid which is liquefied after expansion in an expander (3) of the heat utilization device (1) by a condenser (5) at a certain condensation temperature and the liquid working fluid is then again compressed in a feed pump (6) and reheated in an evaporation heat source (2), said method comprising the steps of:
changing an expansion ratio of the heat utilization device (1) for adjusting the condensation temperature of the working fluid so as to provide for a complete condensation of the working fluid in the condenser (5).

2. The method according to claim 1, wherein the condensation temperature of the working fluid is adjusted by changing a low pressure (P_{U}) in the heat utilization device (1) so as to achieve the complete condensation of the working fluid in the condenser (5).

3. The method according to claim 2, wherein the low pressure (P_{U}) is adjusted by changing an inflow cross-section of an inflow path of the working fluid to the expander (3).

4. The method according to claim 3, wherein the low pressure (P_{U}) is adjusted by changing the inflow cross-section of the inflow path of the working fluid to the expander by means of a slot control.

5. The method according to claim 2, wherein the low pressure (P_{U}) is adjusted by changing a speed of the expander (3).

6. The method according to claim 1, wherein the condensation temperature of the working fluid is adjusted so that the complete condensation of the working fluid takes place in the condenser (5) by changing a high pressure (P_{O}) of the heat utilization device (1)

7. The method according to claim 1, wherein the condensation temperature of the working fluid is adjusted so that the complete condensation of the working fluid takes place in the condenser (5) by changing a working fluid mass flow of the working fluid of the heat utilization device (1).

8. The method according to claim 1, wherein a heat transfer flow (dQ) from the condenser (5) to the working fluid is adjusted by changing the condensation temperature.

9. The method according to claim 8, wherein, during a high load operation of an evaporation heat source (2) of the heat utilization device (1), the condensation temperature of the working fluid in the condenser (5) is increased in order to increase the heat transfer flow (dQ) and thus also to ensure in the high load operation a complete liquefication of the working fluid in the condenser (5).

10. The method according to claim 7, wherein the heat transfer flow (dQ) is additionally adjusted by the working fluid mass flow.

11. The method according to claim 7, wherein the working fluid mass flow is adjusted by changing a feed quantity of the feed pump (6) of the heat utilization device (1).

12. The method according to claim 1, wherein the condensation temperature (T_{U}) of the working fluid is adjusted on the basis of an ambient temperature of the condenser (5) so as to ensure the complete condensation of the working fluid in the condenser (5).

13. The method according to claim 12, wherein the working fluid mass flow is adjusted on the basis of the ambient temperature of the condenser (5) so as to ensure the complete condensation of the working fluid in the condenser (5).

14. The method according to claim 1, wherein a cycle (21) of the heat utilization device (1) is in the form of one of a Carnot cycle, a Clausius Rankine cycle, and a Stirling cycle.

15. The method according to claim 14, wherein at least one of the pressure and the temperature of the working fluid is measured by a sensor unit at least one point of the cycle (21) providing thereby at least one measurement value and the low pressure (P_{U}) is adapted on the basis of the at least one measurement value.

16. A heat utilization device for use as a waste heat utilization device of an internal combustion engine, in particular of a motor vehicle, for implementing a method according to claim 1.
